(19) United States
(12) Patent Application Publication
(10) Pub. No.: US 2023/0275327 A1
(43) Pub. Date: Aug. 31, 2023

(54) ENERGY STORAGE APPARATUS

(71) Applicant: GS Yuasa International Ltd., Kyoto (JP)

(72) Inventors: Hiromu NAKAMURA, Kyoto (JP); Masaki KANEMOTO, Kyoto (JP)

(73) Assignee: GS Yuasa International Ltd., Kyoto (JP)

(21) Appl. No.: 18/015,948

(22) PCT Filed: Jun. 18, 2021
(86) PCT No.: PCT/JP2021/023253

§ 371 Date: Jan. 12, 2023

(30) Foreign Application Priority Data
Jul. 13, 2020 (JP) 2020-119853

(51) Int. Cl. H01M 50/516; H01M 50/503; H01M 50/204; H01M 50/507

(52) U.S. Cl. CPC H01M 50/516; H01M 50/503; H01M 50/204; H01M 50/507; H01M 2220/20

(57) ABSTRACT

An energy storage apparatus includes an energy storage device including an electrode terminal disposed in a first direction, and a bus bar joined to the electrode terminal. The bus bar includes a bus bar body portion including a joint portion joined to the electrode terminal, a first wall portion, and a second wall portion. The first wall portion is erected in the first direction from the bus bar body portion. The second wall portion is disposed so that at least a part of the second wall portion overlaps the bus bar body portion when viewed from the first direction and faces the bus bar body portion.

### TECHNICAL FIELD

The present invention relates to an energy storage apparatus including an energy storage device.

### BACKGROUND ART

Patent Document 1 discloses an assembled battery including a plurality of unit cells. In this assembled battery, a metal line is joined to electrode terminals of adjacent unit cells, and thereby the plurality of unit cells are connected in series or in parallel. Ultrasonic joining is used to join the metal line and the electrode terminals of the unit cells.

### PRIOR ART DOCUMENTS

### Patent Documents

Patent Document 1: JP-A-2014 -222675

### SUMMARY OF THE INVENTION

### Problems to be Solved by the Invention

In a case where ultrasonic joining is used to join an electrode terminal of a unit cell (energy storage device) and a metal line (bus bar) as in the conventional assembled battery (energy storage apparatus), the bus bar may be distorted by pressure applied during joining. In view of this, laser welding capable of joining an object to be joined in a non-contact manner is sometimes adopted for joining a bus bar and an electrode terminal. Laser welding has advantages such as less welding distortion and relatively easy welding between dissimilar materials. However, there is a possibility that spatter, which is molten metal powder, is scattered during laser welding, and the scattered spatter becomes a cause of a defect such as damage of a resin member of an energy storage apparatus. It is conceivable to arrange a three-dimensional structure for preventing spatter scattering near the bus bar, but this, for example, complicates the configuration of the energy storage apparatus.

The present invention has been made by the inventor of the present application in view of the above problems which the inventor newly focused on, and an object of the present invention is to provide an energy storage apparatus having improved quality with a simple configuration.

### Means for Solving the Problems

An energy storage apparatus according to an aspect of the present invention includes an energy storage device including an electrode terminal disposed in a first direction, and a bus bar joined to the electrode terminal, wherein the bus bar includes a bus bar body portion including a joint portion joined to the electrode terminal, a first wall portion erected in the first direction from the bus bar body portion, and a second wall portion disposed so that at least a part of the second wall portion overlaps the bus bar body portion when viewed from the first direction and faces the bus bar body portion.

### Advantages of the Invention

According to the present invention, it is possible to provide an energy storage apparatus having improved quality with a simple configuration.

### BRIEF DESCRIPTION OF THE DRAWINGS

FIG. 1 is a perspective view illustrating an external appearance of an energy storage apparatus according to an embodiment.

FIG. 2 is an exploded perspective view of the energy storage apparatus according to the embodiment.

FIG. 3 is a perspective view illustrating a structural relationship among a bus bar frame, bus bars, and electric equipment according to the embodiment.

FIG. 4 is a perspective view illustrating a state where energy storage devices and the electric equipment are connected to each other through the bus bar according to the embodiment.

FIG. 5 is an exploded perspective view corresponding to FIG. 4.

FIG. 6 is a partially enlarged view illustrating a method for joining the bus bar and the electrode terminals of the energy storage devices according to the embodiment.

FIG. 7 is a partially enlarged view illustrating a configuration of a bus bar and a portion around the bus bar according to a first modification of the embodiment.

FIG. 8 is a partially enlarged view illustrating a configuration of a bus bar and a portion around the bus bar according to a second modification of the embodiment.

FIG. 9 is a perspective view illustrating an external appearance of a bus bar according to a third modification of the embodiment.

FIG. 10 is an exploded perspective view illustrating a connection relationship between the bus bar, and energy storage devices and electric equipment according to the third modification of the embodiment.

### MODE FOR CARRYING OUT THE INVENTION

An energy storage apparatus according to an aspect of the present invention includes an energy storage device including an electrode terminal disposed in a first direction and a bus bar joined to the electrode terminal, wherein the bus bar includes a bus bar body portion including a joint portion joined to the electrode terminal, a first wall portion erected in the first direction from the bus bar body portion, and a second wall portion disposed so that at least a part of the second wall portion overlaps the bus bar body portion when viewed from the first direction and faces the bus bar body portion.

According to this configuration, the first wall portion functions as a wall that suppresses spatter scattering that occurs during joining of the bus bar body portion and the electrode terminal. This suppresses occurrence of a trouble such as damage to other members caused by spatter scattering. The second wall portion is, for example, disposed immediately above the bus bar body portion and can be used as a terminal connected to electric equipment such as a relay or a control circuit. Therefore, effects such as suppression of path resistance between the electrode terminal and the electric equipment and a reduction in size of the energy storage apparatus can be obtained. As described above, the energy storage apparatus according to the present aspect has improve quality with a simple configuration.

The second wall portion may include an opening penetrating in the first direction, and at least a part of the opening may be disposed at a position overlapping the joint portion when viewed from the first direction.

According to this configuration, for example, the bus bar body portion and the electrode terminal can be joined by emitting laser beam from a position facing the bus bar body portion through the opening. That is, the bus bar body portion can be efficiently irradiated with a laser beam through the opening of the second wall portion, and spatter scattering to a portion other than the opening of the second wall portion can be suppressed. As a result, the joint portion having high reliability can be efficiently formed.

The second wall portion may be erected in a direction intersecting the first wall portion from an end portion of the first wall portion, the end portion opposite to the bus bar body portion.

According to this configuration, the bus bar having a configuration in which the bus bar body portion, the first wall portion, and the second wall portion are connected in this order is realized. As a result, effects such as reduction in space volume required for arrangement of the bus bar and further suppression of path resistance between the electrode terminal and the electric equipment can be obtained.

The energy storage apparatus may further include an insulating member disposed between the bus bar body portion and the second wall portion.

According to this configuration, the insulating member is provided between the bus bar body portion and the second wall portion in the bus bar having a structure that has the wall (the first wall portion) rising from the bus bar body portion and is therefore susceptible to external force at a time of collision. With such a configuration, for example, when the first wall portion is deformed by receiving a large external force, the insulating member functions as a member which prevents a portion of the bus bar from coming into contact with another conductive member. Therefore, a possibility that a short circuit occurs at the time of collision or the like is reduced.

The bus bar body portion may include a protruding portion provided at a position not overlapping the second wall portion when viewed from the first direction and protruding in a second direction intersecting the first direction.

According to this configuration, in the structure in which the second wall portion is provided immediately above the bus bar body portion, the bus bar body portion includes the protruding portion that protrudes sideways, and therefore the protruding portion can be used as a pressing portion for pressing the bus bar body portion when joining work is performed by laser welding or the like. As a result, a joint portion having high reliability can be obtained.

The bus bar body portion may be joined to the electrode terminal of each of two energy storage devices arranged side by side.

According to this configuration, the bus bar functions as a conductive member connected to the electric equipment such as a relay or a control circuit, and also functions as a conductive member for connecting at least two energy storage devices arranged side by side in series or in parallel. This contributes to suppression of the path resistance, a reduction in size of the energy storage apparatus, or the like, and as a result, improves the quality of the energy storage apparatus.

Hereinafter, an energy storage apparatus according to an embodiment of the present invention (including a modification thereof) will be described with reference to the drawings. The embodiment described below illustrates a comprehensive or specific example. Numerical values, shapes, materials, constituent elements, positions where the constituent elements are arranged, ways in which the constituent elements are connected, manufacturing processes, the order of the manufacturing processes, and the like illustrated in the following embodiment are merely examples, and are not intended to limit the present invention. In each drawing, dimensions and the like are not strictly illustrated. In the drawings, identical or same constituent elements are given identical reference signs.

In the following description and drawings, a longitudinal direction of an outer case of an energy storage apparatus, a direction in which a plurality of energy storage devices are arranged, or a direction in which long side surfaces of case of the energy storage device face each other is defined as an X-axis direction. A lateral direction of the outer case of the energy storage apparatus, a direction in which short side surfaces of the case of the energy storage device face each other, or a direction in which a pair of electrode terminals in one energy storage device are arranged is defined as a Y-axis direction. A direction in which a body and a lid of the outer case of the energy storage apparatus are arranged, a direction in which a bus bar frame and an energy storage device unit are arranged, or an up-down direction is defined as a Z-axis direction. The X-axis direction, the Y-axis direction, and the Z-axis direction are directions intersecting (orthogonal in the present embodiment) each other. Although the Z-axis direction is not the up-down direction depending on usage, it is assumed in the following description that the Z-axis direction is the up-down direction for convenience of description.

In the following description, for example, an X-axis positive direction indicates an arrow direction of the X axis, and an X-axis negative direction indicates a direction opposite to the X-axis positive direction. The same applies to the Y-axis direction and the Z-axis direction. The term “X-axis direction” means both of or any one of two directions parallel to the X-axis. The same applies to the Y-axis and the Z-axis.

Furthermore, expressions indicating a relative direction or posture, such as parallel and orthogonal, include a direction or posture that is not strictly this direction or posture. For example, a case where two directions are orthogonal to each other not only means a case where the two directions are completely orthogonal to each other, but also means a case where the two directions are substantially orthogonal to each other, that is, a case where there is a difference of, for example, about several percent.

### EMBODIMENT

### 1. General Description of Energy Storage Apparatus

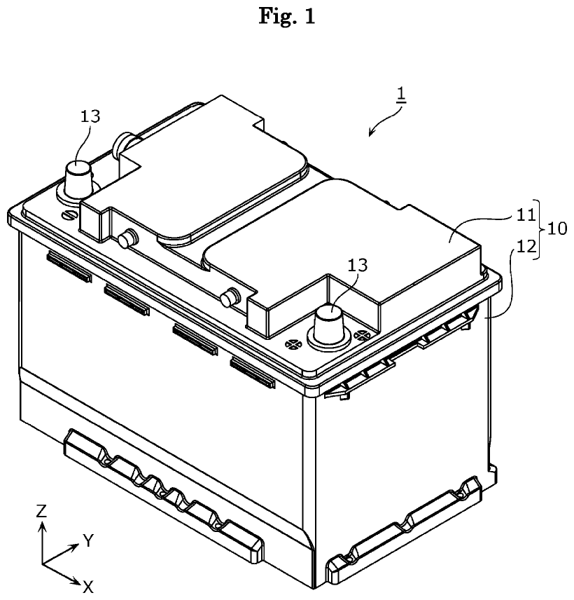

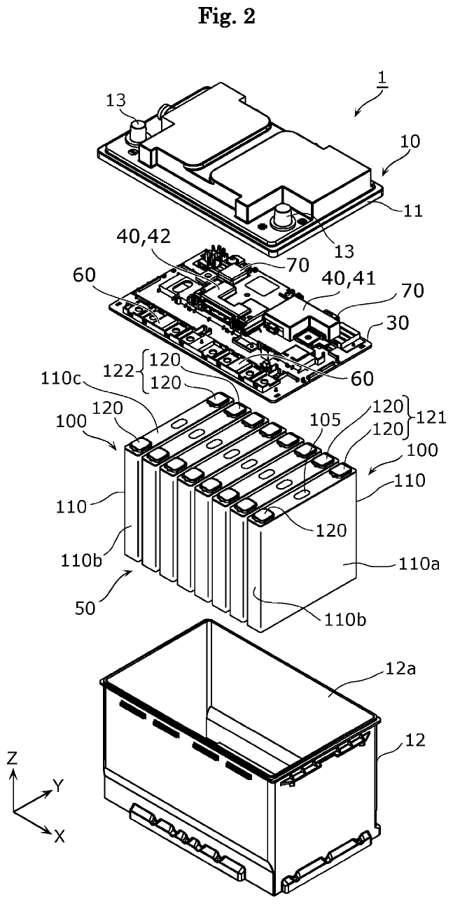

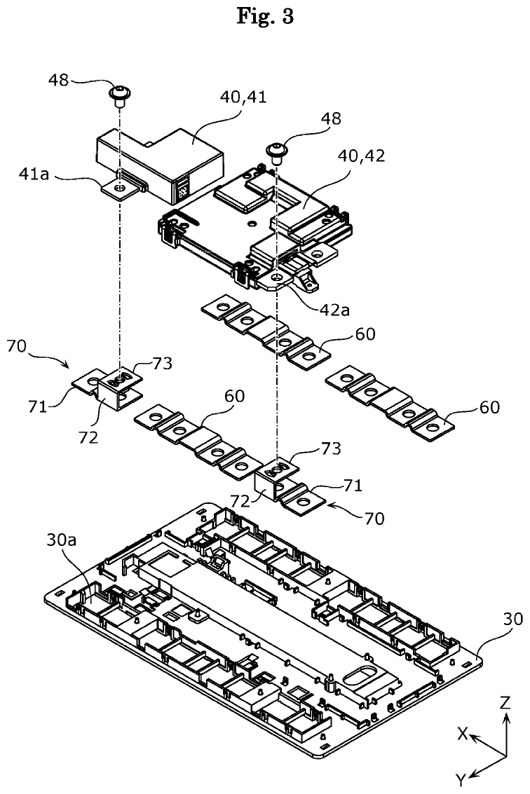

First, a schematic configuration of an energy storage apparatus 1 according to an embodiment will be described. FIG. 1 is a perspective view illustrating an external appearance of the energy storage apparatus 1 according to the embodiment. FIG. 2 is an exploded perspective view of the energy storage apparatus 1 according to the embodiment. FIG. 3 is a perspective view illustrating a structural relationship among a bus bar frame 30, bus bars 60 and 70, and electric equipment 40 according to the embodiment. FIG. 3 illustrates a state in which the bus bars 60 and 70 and the electric equipment 40 are separated from the bus bar frame 30. In FIG. 3, members such as the bus bar frame 30 are illustrated in a state of being rotated by 180° about the Z axis from the posture illustrated in FIG. 2.

Inside an outer case 10, a bus bar that connects the electric equipment 40 and an external terminal 13 to each other is housed, and further, a spacer which is disposed along energy storage devices 100, a binding member that binds the plurality of energy storage devices 100, and the like can be disposed in addition to the members illustrated in FIG. 2 and subsequent drawings. However, illustration and description of these members are appropriately omitted.

The energy storage apparatus 1 is an apparatus capable of being charged with electricity from an outside and discharging electricity to the outside, and has a substantially rectangular parallelepiped shape in the present embodiment. The energy storage apparatus 1 is, for example, a battery module (assembled battery) used for power storage, power supply, or the like. Specifically, the energy storage apparatus 1 is, for example, used as a battery for driving, engine starting, or the like of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a gasoline vehicle. Examples of the railway vehicle for an electric railway include a train, a monorail, a linear motor train, and a hybrid train including both a diesel engine and an electric motor. The energy storage apparatus 1 can also be used as a stationary battery or the like used for household use, a generator, or the like.

As illustrated in FIG. 1 and FIG. 2, the energy storage apparatus 1 includes the outer case 10, and an energy storage device unit 50 and the bus bar frame 30 that are housed in the outer case 10. The outer case 10 is a case (module case) having a box shape (substantially rectangular parallelepiped shape) that forms a housing of the energy storage apparatus 1. That is, the outer case 10 is disposed outward the energy storage device unit 50 and the bus bar frame 30, fixes the energy storage device unit 50 and the bus bar frame 30 at predetermined positions, and protects the energy storage device unit 50 and the bus bar frame 30 from an impact or the like. The outer case 10 is, for example, formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof, or an insulation-coated metal. The outer case 10 thus prevents members such as the energy storage device unit 50 from coming into contact with an external metal member or the like. The outer case 10 may be formed of a conductive member such as a metal as long as electrical insulation between the outer case 10 and the members such as the energy storage device unit 50 is maintained.

The outer case 10 includes an outer case body 12 that forms a body of the outer case 10 and a lid 11. The outer case body 12 is a bottomed rectangular cylindrical housing having an opening 12a on a Z-axis positive direction side, and houses members such as the energy storage device unit 50 and the bus bar frame 30.

The lid 11 is a rectangular member that closes the opening 12a of the outer case body 12. The lid 11 is joined to the outer case body 12 preferably in an airtight or watertight manner by an adhesive, heat sealing, ultrasonic welding, laser welding, or the like. A pair of external terminals 13, which are a pair of positive electrode side and negative electrode side module terminals, are disposed on the lid 11. The energy storage apparatus 1 is charged with electricity from the outside and discharges electricity to the outside through the pair of external terminals 13. The external terminals 13 are, for example, formed of a conductive member made of a metal such as aluminum, an aluminum alloy, copper, or a copper alloy.

The energy storage device unit 50 is an assembly of the energy storage devices 100 which includes one or more energy storage devices 100. The energy storage device unit 50 according to the present embodiment includes the plurality of energy storage devices 100, and the plurality of energy storage devices 100 are arranged in the X-axis direction in a state where long side surfaces 110a face the X-axis direction. The energy storage device unit 50 may include a spacer (not illustrated) disposed between adjacent energy storage devices 100 and may include a binding member (not illustrated) that binds the plurality of energy storage devices 100.

The energy storage devices 100 are secondary batteries (battery cells) capable of being charged with electricity and discharging electricity, and more specifically, are nonaqueous electrolyte secondary batteries such as lithium ion secondary batteries. As illustrated in FIG. 2, each of the energy storage devices 100 includes a case 110 having a flat rectangular parallelepiped shape (prismatic shape) and a pair of (positive electrode side and negative electrode side) electrode terminals 120 fixed to the case 110. An electrode assembly, a current collector, an electrolyte solution, and others (not illustrated) are housed in the case 110. Examples of the electrode assembly included in each of the energy storage devices 100 include a winding-type electrode assembly formed by winding a layered structure including a positive electrode plate, a negative electrode plate, and a separator interposed therebetween. Alternatively, each of the energy storage devices 100 may include a stacked electrode assembly formed by stacking a plurality of plate-shaped electrode plates or a bellows electrode assembly formed by folding an electrode plate in a bellows shape.

The energy storage devices 100 are not limited to the nonaqueous electrolyte secondary batteries, and may be secondary batteries other than the nonaqueous electrolyte secondary batteries or may be capacitors. The energy storage devices 100 may be primary batteries whose stored electricity can be used without charging by a user. The energy storage devices 100 may be batteries using a solid electrolyte. The energy storage devices 100 may be pouch type energy storage devices. The shape of the energy storage devices 100 is not limited to the prismatic shape, and may be a polygonal columnar shape, a cylindrical shape, an elliptical columnar shape, an oval columnar shape or the like.

In the present embodiment, as illustrated in FIG. 2, the case 110 has the pair of long side surfaces 110a, a pair of short side surfaces 110b, and a terminal arrangement surface 110c. The terminal arrangement surface 110c is a surface on which the positive electrode side and negative electrode side electrode terminals 120 are arranged. In the present embodiment, a gas release valve 105 is further disposed on the terminal arrangement surface 110c. The gas release valve 105 is a part that is opened by receiving an internal pressure of the case 110 when the internal pressure of the case 110 excessively rises, and thereby discharges gas inside the case 110 to the outside.

The bus bar frame 30 is a flat rectangular insulating member which is disposed to face the terminal arrangement surfaces 110c of the energy storage devices 100 and holds the bus bars 60 and 70 and the electric equipment 40. The bus bar frame 30 is, for example, formed of any of electrically insulating resin materials or the like that can be used for the outer case 10.

As illustrated in FIG. 3, the bus bar frame 30 has a plurality of bus bar openings 30a which hold the bus bars 60 and 70 in a state where portions of the bus bars 60 and 70 are exposed to the energy storage device 100 side. Each of the bus bars 60 and 70 arranged in the bus bar openings 30a is positioned with respect to the electrode terminal 120, which is a joining partner, and in this state, is joined to the electrode terminal 120, for example, by laser welding. In the present embodiment, the energy storage device unit 50 includes eight energy storage devices 100. Of the eight energy storage devices 100, adjacent two energy storage devices 100 are connected in parallel by the bus bar 60, and thereby four groups of energy storage devices 100 connected in parallel are formed. Furthermore, these four groups of energy storage devices 100 are connected in series by three bus bars 60. The bus bar 70 is joined to each of an overall positive terminal 121 and an overall negative terminal 122 of the energy storage device unit 50 having the eight energy storage devices 100 electrically connected in this manner. In the present embodiment, as illustrated in FIG. 2, the positive electrode side electrode terminals 120 of the two energy storage devices 100 at an end portion in the X-axis positive direction are the overall positive terminal 121, and the negative electrode side electrode terminals 120 of the two energy storage devices 100 at an end portion in the X-axis negative direction are the overall negative terminal 122.

The electric equipment 40 disposed on the bus bar frame 30 is electrically connected to the energy storage device unit 50 through the bus bars 70. In the present embodiment, as illustrated in FIG. 2, the energy storage apparatus 1 includes electric equipment 41 and 42 as the electric equipment 40 disposed on the bus bar frame 30.

The electric equipment 42 is, for example, a control device called a battery management unit (BMU), and detects a voltage of each of the plurality of energy storage devices 100, a temperature of the energy storage device unit 50, and the like, and controls charging states of the plurality of energy storage devices 100. A connection terminal 42a of the electric equipment 42 is connected to the bus bar 70 with a screw 48, and thereby the electric equipment 42 and the two electrode terminals 120 which are the overall negative terminal 122 are electrically and mechanically connected by the bus bar 70. The electric equipment 42 is electrically connected to the negative electrode side external terminal 13 fixed to the lid 11 of the outer case 10 through a bus bar (not illustrated).

The electric equipment 41 is, for example, a relay unit having an electromagnetic switch, and has a function of switching on and off charging or discharging of the energy storage apparatus 1. A connection terminal 41a of the electric equipment 41 is connected to the bus bar 70 with a screw 48, and thereby the electric equipment 41 and the two electrode terminals 120 which are the overall positive terminal 121 are electrically and mechanically connected by the bus bar 70. The electric equipment 41 is electrically connected to the positive electrode side external terminal 13 fixed to the lid 11 of the outer case 10 through a bus bar (not illustrated).

In the energy storage apparatus 1 thus configured, the bus bar 70 which connects the electric equipment 40 and the energy storage device unit 50 to each other includes a bus bar body portion 71, a first wall portion 72, and a second wall portion 73 which are three-dimensionally disposed, as illustrated in FIG. 3. A configuration of the bus bar 70 having such a characteristic shape and a portion around the bus bar 70 will be described below.

### 2. Configuration of Bus Bar and Portion Around Bus Bar

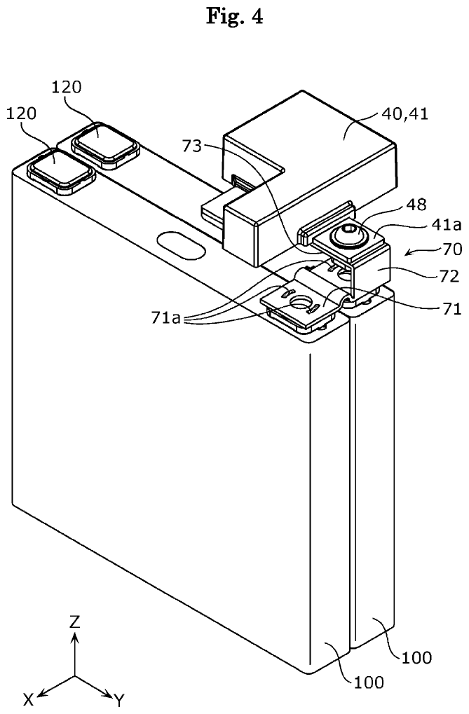

Next, a configuration of the bus bar 70 and a portion around the bus bar 70 in the energy storage apparatus 1 will be described with reference to FIGS. 4 to 6. In the present embodiment, two bus bars 70 which connect the energy storage device unit 50 and the electric equipment 40 to each other are provided, and these two bus bars 70 have a common feature. Therefore, the following description focuses on the bus bar 70 connected to the electric equipment 41, and illustration and description of the bus bar 70 connected to the electric equipment 42 will be omitted.

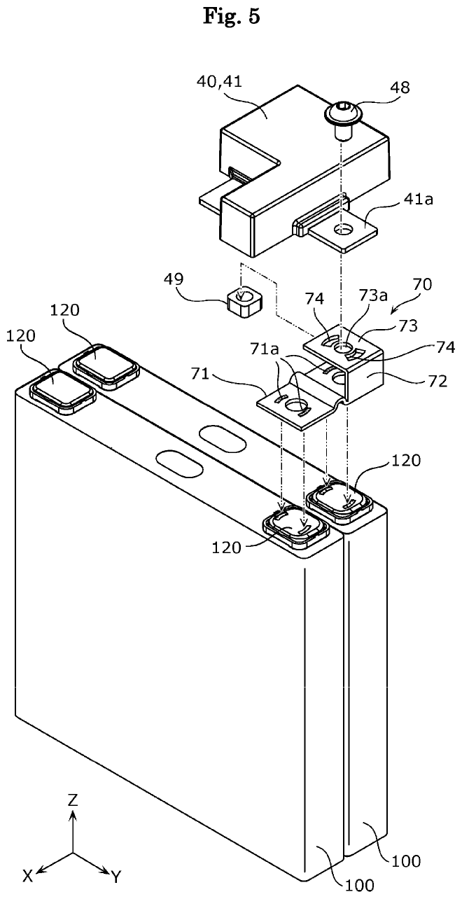

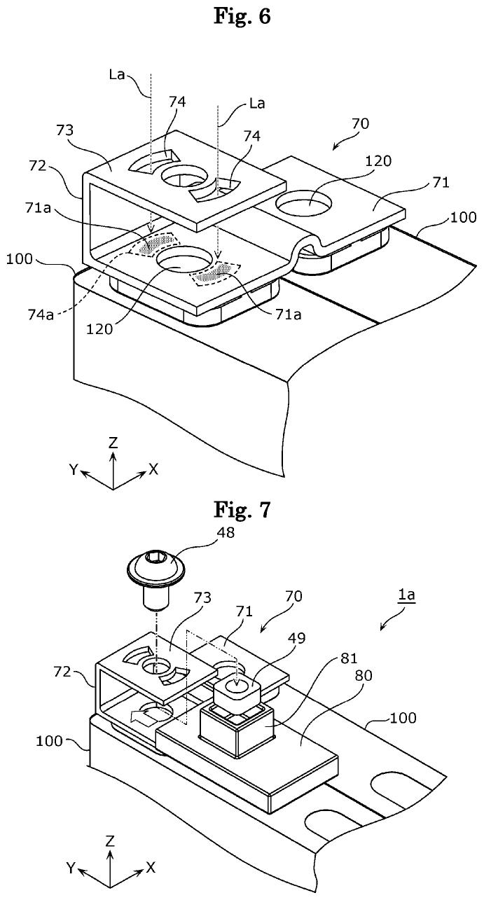

FIG. 4 is a perspective view illustrating a state where the energy storage devices 100 and the electric equipment 41 are connected to each other through the bus bar 70 according to the embodiment. In FIG. 4, only the bus bar 70 and the two energy storage devices 100 and the electric equipment 41 connected to the bus bar 70 are illustrated, and other members such as the other energy storage devices 100 and the bus bar frame 30 are not illustrated. FIG. 5 is an exploded perspective view corresponding to FIG. 4. FIG. 6 is a partially enlarged view illustrating a method for joining the bus bar 70 and the electrode terminals 120 of the energy storage devices 100 according to the embodiment.

As illustrated in FIGS. 4 to 6, in the energy storage apparatus 1 according to this embodiment, each of the energy storage devices 100 has the electrode terminal 120 in the Z-axis positive direction, which is an example of a first direction. The electrode terminal 120 and the bus bar 70 are joined at a joint portion 71a provided in the bus bar body portion 71 of the bus bar 70. The joint portion 71a is formed by laser welding in the present embodiment. In the present embodiment, the bus bar body portion 71 has a through hole through which a bolt passes in order to enable joining with a bolt terminal, but the bus bar body portion 71 may have no through hole for joining with a bolt terminal.

The bus bar 70 further includes the first wall portion 72 erected in the Z-axis positive direction from bus bar body portion 71. That is, the first wall portion 72 exists as a metal shielding wall for partitioning from a space on the Y-axis positive direction side when viewed from the joint portion 71a. Therefore, even in a case where spatter occurs during laser welding for forming the joint portion 71a, at least scattering of the spatter toward the Y-axis positive direction side of the bus bar 70 is suppressed. Since the laser welding is performed in a state where the energy storage device unit 50 is housed in the outer case body 12, damage caused by the spatter on portions of the outer case body 12 and the bus bar frame 30 located on the Y-axis positive direction side of the bus bar 70 is suppressed by the first wall portion 72.

Furthermore, the second wall portion 73 is fixed to the first wall portion 72 so as to face the bus bar body portion 71. The second wall portion 73 has an attachment hole 73a for connection with the electric equipment 41, and the bus bar 70 and the electric equipment 41 are connected to each other by screwing the screw 48 inserted through the connection terminal 41a of the electric equipment 41 and into the attachment hole 73a, and a nut 49. That is, the electric equipment 41 is connected to the electrode terminals 120 in a state where a conduction path between the electric equipment 41 and the electrode terminal 120 is relatively short. The second wall portion 73 further has an opening 74. As illustrated in FIG. 6, the opening 74 is used as a hole through which a laser beam La passes during the laser welding between the bus bar body portion 71 and the electrode terminal 120 of the energy storage device 100. That is, since the second wall portion 73 has the opening 74, the bus bar body portion 71 can be irradiated with the laser beam La from a position opposite to the bus bar body portion 71 across the second wall portion 73.

As described above, the energy storage apparatus 1 according to the present embodiment includes the energy storage device 100 including the electrode terminal 120 disposed in the Z-axis positive direction, and the bus bar 70 joined to the electrode terminal 120. The bus bar 70 includes the bus bar body portion 71 having the joint portion 71a joined to the electrode terminal 120, the first wall portion 72, and the second wall portion 73. The first wall portion 72 is erected in the Z-axis positive direction from the bus bar body portion 71. The second wall portion 73 is disposed so that at least a part of the second wall portion overlaps the bus bar body portion 71 when viewed from the Z-axis positive direction and faces the bus bar body portion 71.

According to this configuration, for example, the first wall portion 72 functions as a wall that suppresses spatter scattering that occurs during joining of the bus bar body portion 71 and the electrode terminal 120. This suppresses occurrence of a trouble such as damage to other members such as the bus bar frame 30 and the outer case body 12 caused by spatter scattering. The second wall portion 73 is disposed immediately above the bus bar body portion 71 (on the Z-axis positive direction side), and can be used as a terminal connected to the electric equipment 41. Therefore, effects such as suppression of path resistance between the electrode terminal 120 and the electric equipment 41 and a reduction in size of the energy storage apparatus 1 can be obtained. In the present embodiment, the bus bar 70 is a member which directly connects the energy storage device unit 50 and the electric equipment 40 (41, 42) in a main current path through which a current flows during discharging and charging of the energy storage device unit 50. Therefore, since the path resistance in the bus bar 70 is relatively small, for example, the charge-discharge efficiency of the energy storage apparatus 1 is improved. As described above, the energy storage apparatus 1 according to the present aspect can improve quality with a simple configuration.

In the present embodiment, the first wall portion 72 is located outside the joint portion 71a (on the Y-axis positive direction side in FIGS. 4 to 6) when viewed from a center of the energy storage device 100 in top view. However, the first wall portion 72 may be located on an inner side of the joint portion 71a (on the Y-axis negative direction side in FIGS. 4 to 6). However, it is advantageous that the first wall portion 72 is located outside the joint portion 71a from a viewpoint of protecting a peripheral edge portion (see FIG. 2) of the opening 12a of the outer case body 12. Specifically, in a case where the first wall portion 72 is located outside the joint portion 71a, the first wall portion 72 is disposed between a portion of the peripheral edge portion of the opening 12a closest to the joint portion 71a and the joint portion 71a. With this configuration, the first wall portion 72 can protect the peripheral edge portion of the opening 12a that has not been joined to the lid 11 yet from spatter generated during formation of the joint portion 71a. Therefore, a possibility that the peripheral edge portion of the opening 12a is deformed or damaged by spatter is reduced. As a result, the lid 11 and the outer case body 12 can be joined to each other with high accuracy by welding or the like.

In the present embodiment, the second wall portion 73 has the opening 74 penetrating in the Z-axis positive direction, and at least a part of the opening 74 is disposed at a position overlapping the joint portion 71a when viewed from the Z-axis positive direction. Specifically, as illustrated in FIG. 6, the joint portion 71a is formed inside a projection region (opening region 74a) of opening in the opening 74 on the bus bar body portion 71. That is, a part of the opening 74 overlaps the joint portion 71a when viewed from the Z-axis positive direction.

According to this configuration, the bus bar body portion 71 and the electrode terminal 120 can be joined by emitting laser beam from a position facing the bus bar body portion 71 through the opening 74. That is, the bus bar body portion 71 can be irradiated with the laser beam from a direction parallel to a thickness direction of the bus bar body portion 71 (from a direction perpendicular to a surface of the bus bar body portion 71). That is, the bus bar body portion 71 can be efficiently irradiated with the laser beam through the opening 74 of the second wall portion 73. Furthermore, spatter scattering to portions other than the opening 74 of the second wall portion 73 can be suppressed. As a result, the joint portion 71a having high reliability can be efficiently formed.

In the present embodiment, the second wall portion 73 is erected in a direction intersecting the first wall portion 72 from an end portion (end portion in the Z-axis positive direction) of the first wall portion 72, the end portion opposite to the bus bar body portion 71.

According to this configuration, the bus bar 70 having a configuration in which the bus bar body portion 71, the first wall portion 72, and the second wall portion 73 are connected in this order is realized. As a result, effects such as reduction in space volume required for arrangement of the bus bar 70 and further suppression of path resistance between the electrode terminal 120 and the electric equipment 40 can be obtained.

In the present embodiment, as illustrated in FIGS. 2 to 6, the bus bar body portion 71 is joined to the electrode terminal 120 of each of the two energy storage devices 100 arranged side by side.

That is, in the present embodiment, the bus bar 70 functions as a conductive member connected to the electric equipment 40, and also functions as a conductive member for connecting at least two energy storage devices 100 arranged side by side in series or in parallel (in the present embodiment, in parallel). This contributes to suppression of the path resistance, a reduction in size of the energy storage apparatus 1, or the like, and as a result, improves the quality of the energy storage apparatus 1.

Although the energy storage apparatus 1 according to the embodiment has been described above, the energy storage apparatus 1 may have a configuration different from the configuration illustrated in FIGS. 4 to 6 as for the bus bar 70 and a portion around the bus bar 70. Therefore, modifications of the configuration of the bus bar 70 and a portion around the bus bar 70 will be described below focusing on a difference from the above embodiment.

### First Modification

FIG. 7 is a partially enlarged view illustrating a configuration of a bus bar 70 and a portion around the bus bar 70 according to a first modification of the embodiment. In FIG. 7, illustration of electric equipment 40 connected to the bus bar 70 is omitted, and an insulating member 80 is shifted in the Y-axis negative direction from an original position.

As illustrated in FIG. 7, in an energy storage apparatus la according to the first modification, the insulating member 80 is attached to the bus bar 70, and this point is different from the energy storage apparatus 1 according to the embodiment. Specifically, the energy storage apparatus la includes the insulating member 80 disposed between a bus bar body portion 71 and a second wall portion 73.

As described above, in the present modification, the insulating member 80 is provided between the bus bar body portion 71 and the second wall portion 73 in the bus bar 70 having a structure that has a wall (first wall portion 72) rising from the bus bar body portion 71 and is therefore susceptible to external force at a time of collision. With such a configuration, for example, when the first wall portion 72 is deformed by receiving a large external force, the insulating member 80 functions as a member which prevents a portion of the bus bar 70 from coming into contact with another conductive member such as a case 110 of an energy storage device 100. Therefore, a possibility that a short circuit occurs at the time of collision or the like is reduced.

In the present embodiment, the insulating member 80 includes a nut holding portion 81 that holds a nut 49. The nut holding portion 81 is a non-circular concave portion that covers an outer periphery of the nut 49 having a non-circular outer shape when viewed from an axial direction (Z-axis direction) of the nut 49, and therefore also functions as a rotation stopper of the nut 49. This makes it possible to perform work of attaching the electric equipment 40 easily and reliably to the bus bar 70 by using a screw 48 and the nut 49. Further, a peripheral surface and a lower surface (a surface on the energy storage device 100 side (the Z-axis negative direction side)) of the nut 49 are covered with the insulating member 80. Therefore, even when the nut 49 moves due to deformation of the bus bar 70 at the time of collision or the like, a possibility that another member is damaged by the nut 49 which is a metal body is reduced. That is, the insulating member 80 according to the present modification functions as a member for improving safety and also functions as a member for improving manufacturing efficiency of the energy storage apparatus 1a.

In the present modification, the first wall portion 72 is disposed at an end portion on an outer side (Y-axis positive direction side in FIG. 7) of the bus bar body portion 71 when viewed from the center of the energy storage device 100 in top view. Therefore, as illustrated in FIG. 7, the insulating member 80 can be easily disposed on the bus bar 70 from an inner side. On the other hand, if the first wall portion 72 is erected at an end portion on the inner side (Y-axis negative direction side) of the bus bar body portion 71, it is difficult to dispose the insulating member 80 from the outer side of the bus bar 70. Specifically, since a peripheral edge portion (see FIG. 2) of an opening 12a of an outer case body 12 exists in the vicinity of the outer side of the bus bar 70, there is a high possibility that the peripheral edge portion gets in the way of disposing the insulating member 80. That is, it is advantageous that the first wall portion 72 is erected at the end portion on the outer side of the bus bar body portion 71 from a viewpoint of ease of disposing the insulating member 80 between the bus bar body portion 71 and the second wall portion 73.

### Second Modification

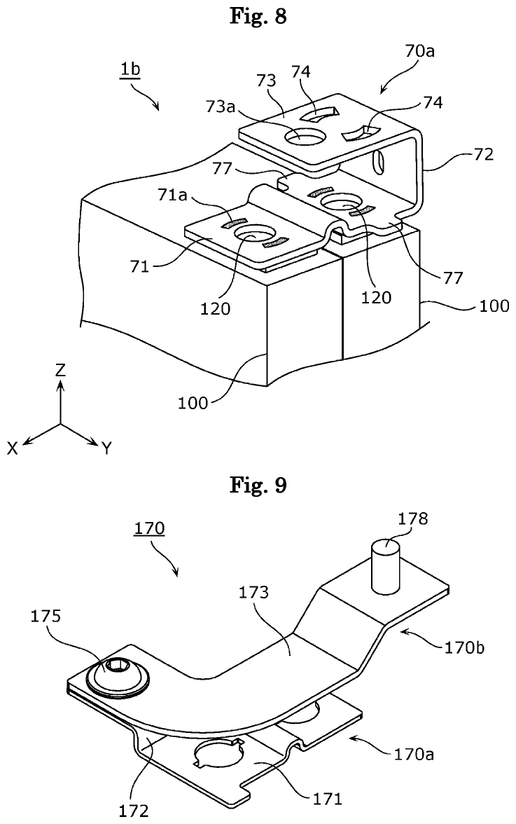

FIG. 8 is a partially enlarged view illustrating a configuration of a bus bar 70a and a portion around the bus bar 70a according to a second modification of the embodiment. In FIG. 8, illustration of electric equipment 40 connected to the bus bar 70a is omitted.

As illustrated in FIG. 8, the bus bar 70a included in an energy storage apparatus 1b according to the second modification includes a bus bar body portion 71 joined to an electrode terminal 120 of an energy storage device 100, a first wall portion 72 erected in the Z-axis positive direction from the bus bar body portion 71, and a second wall portion 73 disposed so as to face the bus bar body portion 71. In this configuration, the bus bar 70a according to the present modification and the bus bar 70 according to the embodiment are identical. In the bus bar 70a according to the present modification, the first wall portion 72 is erected at an end portion of the bus bar body portion 71 in the X-axis negative direction in such a posture that a thickness direction thereof is directed in a direction (X-axis direction) in which the energy storage devices 100 are arranged. Furthermore, the second wall portion 73 is erected in the X-axis positive direction from an end portion of the first wall portion 72 in the Z-axis positive direction. That is, the bus bar 70 according to the embodiment has a U shape as a whole when viewed from the X-axis direction, whereas the bus bar 70a according to the present modification has a U shape as a whole when viewed from the Y-axis direction. Even in this case, the first wall portion 72 functions as a wall that suppresses spatter scattering that occurs during joining of the bus bar body portion 71 and the electrode terminal 120. Since the second wall portion 73 can be connected to the electric equipment 40 at a position close to the bus bar body portion 71, path resistance between the energy storage device 100 and the electric equipment 40 is relatively small. Furthermore, since the second wall portion 73 has an opening 74, the bus bar body portion 71 can be efficiently irradiated with a laser beam through the opening 74.

Furthermore, in the present modification, the bus bar body portion 71 includes a protruding portion 77 that is provided at a position not overlapping the second wall portion 73 when viewed from the Z-axis positive direction and protrudes in a second direction (the Y-axis direction in the present modification) intersecting the Z-axis positive direction.

As described above, in the structure in which the second wall portion 73 is provided immediately above the bus bar body portion 71, the bus bar body portion 71 has the protruding portion 77 that protrudes sideways, and therefore the protruding portion 77 can be used as a pressing portion for pressing the bus bar body portion 71 when joining work is performed by laser welding or the like. As a result, a joint portion 71a having high reliability can be obtained. The protruding portion 77 can also be used, for example, as an attachment portion to which an electric wire for voltage measurement is attached. The number and position of the protruding portion 77 are not particularly limited. For example, the bus bar body portion 71 may further include a protruding portion 77 that is disposed at an end portion in the X-axis positive direction and protrudes in the X-axis positive direction.

### Third Modification

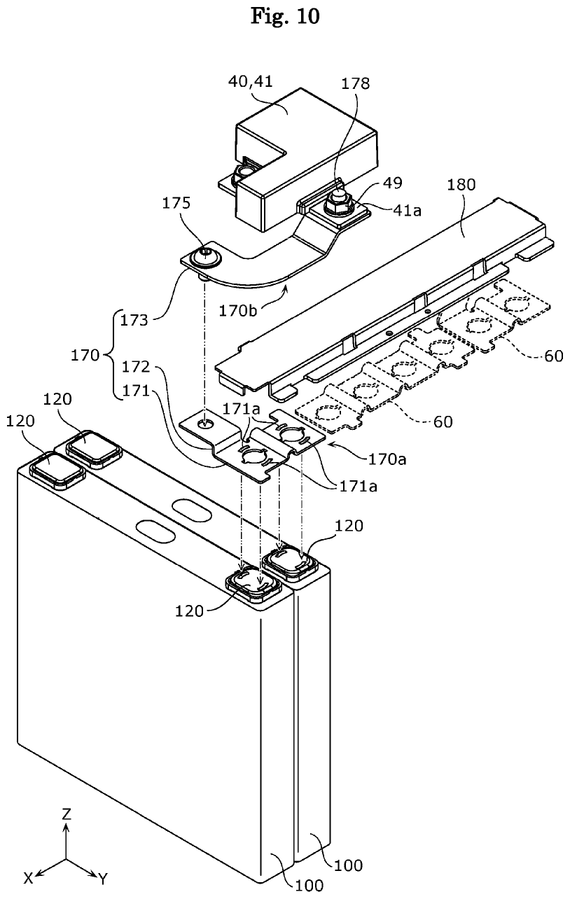

FIG. 9 is a perspective view illustrating an external appearance of a bus bar 170 according to a third modification of the embodiment. FIG. 10 is an exploded perspective view illustrating a connection relationship between the bus bar 170, and energy storage devices 100 and electric equipment 41 according to the third modification of the embodiment. In FIG. 10, only two energy storage devices 100 to which the bus bar 170 is joined are illustrated, and illustration of other energy storage devices 100 is omitted. In FIG. 10, a bus bar 60 joined to the other energy storage devices 100 is indicated by the dotted lines, and illustration of other members such as a bus bar frame is omitted.

As illustrated in FIGS. 9 and 10, the bus bar 170 according to the present modification includes a bus bar body portion 171 having a joint portion 171a joined to an electrode terminal 120, a first wall portion 172, and a second wall portion 173. The first wall portion 172 is erected in the Z-axis positive direction from the bus bar body portion 171. The second wall portion 173 is disposed so that at least a part thereof overlaps the bus bar body portion 171 and faces the bus bar body portion 171 when viewed from the Z-axis positive direction. These configurations are identical to those of the bus bar 70 according to the embodiment.

The bus bar 170 according to the present modification is different from the bus bar 70 according to the embodiment in that bus bar 170 is formed by joining two bus bars. Specifically, the bus bar 170 includes a first bus bar 170a forming the bus bar body portion 171 and the first wall portion 172, and a second bus bar 170b forming the second wall portion 173. The first bus bar 170a and the second bus bar 170b are joined by a joining member 175 including a bolt and a nut (not illustrated).

Even in a case where the bus bar 170 is made up of a plurality of members as described above, the first wall portion 172 functions as a wall that suppresses spatter scattering that occurs during joining of the bus bar body portion 171 and the electrode terminal 120. The second wall portion 173 is disposed immediately above the bus bar body portion 171 (on the Z-axis positive direction side), and can be used as a terminal connected to the electric equipment 41. Therefore, effects such as suppression of path resistance between the electrode terminal 120 and the electric equipment 41 and a reduction in size of the energy storage apparatus 1 can be obtained. Specifically, in the present modification, the second bus bar 170b has a screw shaft portion 178 for connection with the electric equipment 41, and as illustrated in FIG. 10, the screw shaft portion 178 inserted through a connection terminal 41a of the electric equipment 41 and a nut 49 are screwed together, and thereby the bus bar 170 and the electric equipment 41 are connected. A method for joining the second bus bar 170b and the electric equipment 41 is not particularly limited. The second bus bar 170b and the electric equipment 41 may be joined to each other by welding or swaging.

Further, in the present modification, an insulating member 180 is disposed between the bus bar body portion 171 and the second wall portion 173, as in the first modification. With such a configuration, for example, when the first wall portion 172 is deformed by receiving a large external force, the insulating member 180 functions as a member which prevents the second bus bar 170b from coming into contact with another conductive member such as a case 110 of the energy storage device 100. Therefore, a possibility that a short circuit occurs at the time of collision or the like is reduced. As illustrated in FIG. 10, the insulating member 180 according to the present modification is a bus bar cover that collectively covers the bus bar body portion 171 and the bus bar 60. That is, the insulating member 180 can protect not only the bus bar body portion 171, which is a part of the bus bar 170, but also one or more bus bars 60. In other words, a portion of the bus bar cover which protects one or more bus bars 60 is used to improve reliability of electrical insulation between the second bus bar 170b and other conductive members such as the case 110 of the energy storage device 100.

The first wall portion 172 of the bus bar 170 may be formed by a part of the second bus bar 170b instead of the first bus bar 170a. A position of the first wall portion 172 is not necessarily an end portion on an inner side (the Y-axis negative direction side in FIG. 10) of the bus bar body portion 171. The first wall portion 172 may be provided at an end portion on an outer side (the Y-axis positive direction side) of the bus bar body portion 171. The first wall portion 172 may be provided at one of both end portions in a width direction (X-axis direction) of the bus bar body portion 171. A method for joining the first bus bar 170a and the second bus bar 170b is not limited to fastening using a bolt and a nut. For example, the first bus bar 170a and the second bus bar 170b may be joined by another joining method such as welding or swaging. The number of separate bus bars constituting the bus bar 170 is not limited to two. One bus bar 170 may be configured by connecting three or more bus bars.

### Other Embodiments

Although the energy storage apparatus 1 according to the embodiment of the present invention has been described above, the present invention is not limited to this embodiment. That is, the embodiment disclosed herein is illustrative and is not restrictive in all respects, and the scope of the present invention encompasses all changes within the meaning and scope equivalent to the claims.

For example, the bus bar 70 and the electric equipment 40 may not be directly connected. For example, an electric wire connected to the electric equipment 42 that is a BMU may be connected to the attachment hole 73a provided in the second wall portion 73 of the bus bar 70 by a screw or the like. A member that is supposed to be energized (energized member), such as the electric equipment 40, need not necessarily be connected to the second wall portion 73 of the bus bar 70. For example, a non-energized member such as the lid 11 may be connected to the second wall portion 73 of the bus bar 70 by engagement, fitting, bonding, screwing, or the like. In this case, the bus bar 70 can function as a member that supports the non-energized member. The first wall portion 72 may be used as a connection portion for connection with the energized member. For example, in a state where the electrode terminal 120 is joined to the bus bar body portion 71 and the electric equipment 40 is attached to the second wall portion 73, an energized member such as an electric wire for voltage measurement or a non-energized member such as the lid 11 may be further connected to the first wall portion 72. In this case, the first wall portion 72 may be provided with a hole, a notch, a convex part, or the like for attaching the energized member or the non-energized member.

That is, the bus bar 70 according to the present embodiment has an additional connection margin (connectable region) formed by the first wall portion 72 and the second wall portion 73 while having a size substantially the same as that of the bus bar body portion 71 in top view (when viewed from the Z-axis positive direction). Therefore, according to the bus bar 70, the plurality of energy storage devices 100 can be electrically and mechanically connected in a relatively small space, and furthermore, it is possible to form a conduction path between the plurality of energy storage devices 100 and the electric equipment 40 and the like, and to support other members by mechanical connection.

The number of energy storage devices 100 directly connected to the bus bar body portion 71 of the bus bar 70 is not limited to two, and it is only necessary that the electrode terminal 120 of one or more energy storage devices 100 is joined to the bus bar body portion 71. For example, the bus bar 60 (see FIG. 3) connecting the four energy storage devices 100 to each other may have a first wall portion erected in the Z-axis positive direction and a second wall portion arranged so as to face the bus bar 60. That is, a three-dimensional structure formed by a combination of three plate-like portions (a bus bar body portion, a first wall portion, and a second wall portion), which is a feature of the bus bar 70, may be adopted in any bus bar as long as the bus bar is connected to any one of the plurality of energy storage devices 100. To which bus bar the three-dimensional structure is applied may be appropriately determined according to the number, type, size, or arrangement position of the electric equipment 40 included in the energy storage apparatus 1, or the size, shape, or the like of the outer case 10.

Any combination of the constituent elements included in the above embodiment and the modifications thereof is also encompassed within the scope of the present invention.

### INDUSTRIAL APPLICABILITY

The present invention can be applied to an energy storage apparatus including an energy storage device such as a lithium ion secondary battery.

### DESCRIPTION OF REFERENCE SIGNS

1, 1a, 1b: energy storage apparatus
30: bus bar frame
40, 41, 42: electric equipment
50: energy storage device unit
60, 70, 70a, 170: bus bar
71, 171: bus bar body portion
71a, 171a: joint portion
72, 172: first wall portion
73, 173: second wall portion
73a: attachment hole
74: opening
74a: opening region
77: protruding portion
80, 180: insulating member
100: energy storage device
120: electrode terminal

1. An energy storage apparatus comprising:
an energy storage device including an electrode terminal disposed in a first direction; and
a bus bar joined to the electrode terminal,
wherein the bus bar includes:
a bus bar body portion including a joint portion joined to the electrode terminal;
a first wall portion erected in the first direction from the bus bar body portion; and
a second wall portion disposed so that at least a part of the second wall overlaps the bus bar body portion when viewed from the first direction and faces the bus bar body portion.

2. The energy storage apparatus according to claim 1, wherein the second wall portion includes an opening penetrating in the first direction, and at least a part of the opening is disposed at a position overlapping the joint portion when viewed from the first direction.

3. The energy storage apparatus according to claim 1, wherein the second wall portion is erected in a direction intersecting the first wall portion from an end portion of the first wall portion, the end portion opposite to the bus bar body portion.

4. The energy storage apparatus according to claim 1, further comprising an insulating member disposed between the bus bar body portion and the second wall portion.

5. The energy storage apparatus according to claim 1, wherein the bus bar body portion includes a protruding portion provided at a position not overlapping the second wall portion when viewed from the first direction and protruding in a second direction intersecting the first direction.

6. The energy storage apparatus according to claim 1, wherein the bus bar body portion is joined to the electrode terminal of each of two energy storage devices arranged side by side.
